(19) United States
(12) Patent Application Publication
(10) Pub. No.: US 2013/0046060 A1
(43) Pub. Date: Feb. 21, 2013

(54) MATERIAL FOR GOLF BALL AND GOLF BALL

(71) Applicant: Toshiyuki TARAO, Kobe-shi (JP)

(72) Inventor: Toshiyuki TARAO, Kobe-shi (JP)

(21) Appl. No.: 13/588,264

(22) Filed: Aug. 17, 2012

(30) Foreign Application Priority Data
Aug. 18, 2011 (JP) 2011-179082

(51) Int. Cl. C08L 33/10

(52) U.S. Cl. 525/228

(57) ABSTRACT

The present invention provides a material for a golf ball which increases the spin rate in wet conditions and allows a golf ball to stop well on approach shots, and a golf ball produced using the material for a golf ball. The present invention relates to a material for a golf ball including an acrylic elastomer, and having shear loss moduli G1″ (Pa) and G2″ (Pa) which satisfy the following inequality (1):

G1″/G2″>1.65 (1)

when the shear loss moduli are measured with a dynamic viscoelasticity apparatus under measurement conditions for G1″ of mode: shear, vibration frequency: 10 Hz, temperature: −30° C., and strain: 0.05%, and measurement conditions for G2″ of mode: shear, vibration frequency: 10 Hz, temperature: 0° C., and strain: 0.05%.

### TECHNICAL FIELD

The present invention relates to a material for a golf ball, and a golf ball produced using the material for a golf ball.

### BACKGROUND ART

Golf balls of various structures have been proposed such as one-piece golf balls which consist of a golf ball body, two-piece golf balls having a core and a cover, three-piece golf balls which have a core including a center and a single intermediate layer covering the center and a cover covering the core, and multi-piece golf balls which have a core including a center and at least two intermediate layers covering the center and a cover covering the core.

Ionomer resins or polyurethane are used as materials for these golf balls, and are widely used as materials for covers. Covers containing polyurethane, in particular, are known to give better shot feeling and spin performance than covers containing ionomer resins, and thus are widely used for golf balls that are demanded to have these performances.

Meanwhile, in the pro golf world, new groove regulations began to apply to golf clubs having a loft angle greater than or equal to 25 degrees, such as irons and wedges, in 2010. The regulations reduce the spin rate on approach shots with wedges, short irons and the like, and thus the golf balls would not stop easily on the green. Particularly in wet conditions, since golf balls tend to slip on the clubface, it is disadvantageously difficult to create spin.

In order to overcome this problem, use of a soft cover material has been proposed to increase the spin rate on approach shots. For example, Patent Literature 1 discloses a golf ball including a cover which contains a thermoplastic polyurethane elastomer as a main component and has a hardness of not more than 54 in Shore D hardness. Moreover, Patent Literature 2 discloses a solid golf ball including a cover which is constituted of a mixture of an ionomer resin, a thermoplastic elastomer and a tackifier, and has a Shore D hardness of at least 40 but not more than 65.

However, after introduction of the golf club groove regulations, golf balls which spin sufficiently even in wet conditions and stop well on approach shots have been demanded more and more. Hence, further improvement in the performance of golf balls has been desired.

### CITATION LIST

### Patent Literature

Patent Literature 1: JP-A 2006-034740
Patent Literature 2: JP-A 2001-95948

### SUMMARY OF INVENTION

### Technical Problem

The present invention aims to solve the above problems and provide a material for a golf ball which increases the spin rate in wet conditions and allows a golf ball to stop well on approach shots, and a golf ball produced using the material for a golf ball.

### Solution to Problem

The inventor of the present invention has found that, as disclosed in a graph in FIG. 1 of JP-A 2011-125438 showing a correlation between the shear loss modulus (measurement conditions: mode shear, vibration frequency 10 Hz, and temperature 0° C.) of a golf ball which includes a cover made from an H₁₂MDI-PTMG polyurethane elastomer and the spin rate on approach shots, the shear loss modulus G″ correlates with the spin rate in a manner that a smaller shear loss modulus G″ tends to lead to a higher spin rate on approach shots.

As a result of further investigation on this finding, the inventor of the present invention has found that use of an acrylic elastomer which satisfies the inequality: shear loss modulus G1″ (measurement conditions: mode shear, vibration frequency 10 Hz, temperature −30° C., and strain 0.05%)/shear loss modulus G2″ (measurement conditions: mode shear, vibration frequency 10 Hz, temperature 0° C., and strain 0.05%)>1.65 increases the wet spin rate on approach shots, and thereby completed the present invention.

The present invention relates to a material for a golf ball including an acrylic elastomer, and having shear loss moduli G1″ (Pa) and G2″ (Pa) which satisfy the following inequality (1):

G1″/G2″>1.65 (1)

when the shear loss moduli are measured with a dynamic viscoelasticity apparatus under measurement conditions for G1″ of mode: shear, vibration frequency: 10 Hz, temperature: −30° C., and strain: 0.05%, and measurement conditions for G2″ of mode: shear, vibration frequency: 10 Hz, temperature: 0° C., and strain: 0.05%.

The acrylic elastomer is preferably an acrylic block copolymer which includes, in a molecule thereof, at least one polymer block (I) including an acrylic acid ester polymer and at least one polymer block (II) including a methacrylic acid ester polymer.

The acrylic elastomer is preferably an acrylic block copolymer which includes, in a molecule thereof, at least one triblock structure of the formula: (II)-(I)-(II) or the formula: (I)-(II)-(I) (wherein (I) represents a polymer block including an acrylic acid ester polymer, (II) represents a polymer block including a methacrylic acid ester polymer, and - represents a bond between the polymer blocks).

The acrylic elastomer is preferably an acrylic block copolymer which includes, in a molecule thereof, at least one triblock structure of the formula: (II)-(I)-(II) (wherein (I) represents a polymer block including an acrylic acid ester polymer, (II) represents a polymer block including a methacrylic acid ester polymer, and - represents a bond between the polymer blocks).

In a preferred embodiment of the acrylic elastomer, the polymer block (I) includes an n-butyl acrylate polymer, and the polymer block (II) includes a methyl methacrylate polymer.

The material for a golf ball preferably has a slab hardness of 19 to 61 in Shore D hardness.

The material for a golf ball is preferably used as a cover material.

The acrylic acid ester polymer is preferably derived from an acrylic acid alkyl ester in which the alkyl group has a number of carbon atoms of at least two but not more than 10.

The methacrylic acid ester polymer is preferably derived from a methacrylic acid alkyl ester in which the alkyl group has a number of carbon atoms of not more than 10.

Preferably, the amount of the polymer block (I) (in the case where not less than two polymer blocks (I) are included, the total amount of the polymer blocks (I)) relative to the total mass of the acrylic block copolymer is at least 25% by mass but not more than 95% by mass, and

the amount of the polymer block (II) (in the case where not less than two polymer blocks (II) are included, the total amount of the polymer blocks (II)) relative to the total mass of the acrylic block copolymer is at least 5% by mass but not more than 75% by mass.

The polymer block (I) preferably has a weight average molecular weight of at least 2000 but not more than 400000.

The polymer block (II) preferably has a weight average molecular weight of at least 1000 but not more than 400000.

The present invention also relates to a golf ball which includes a member formed of the material for a golf ball.

### Advantageous Effects of Invention

The material for a golf ball according to the present invention includes an acrylic elastomer satisfying the inequality: [shear loss modulus G1″]/[shear loss modulus G2″]>1.65, and thus it can increase the wet spin rate. Accordingly, a high spin rate can be achieved even in wet conditions, and therefore golf balls which stop well on approach shots can be provided.

### BRIEF DESCRIPTION OF DRAWINGS

FIG. 1 is a graph showing the spin rate on approach shots (WET) as a function of the slab hardness (Shore D).

FIG. 2 is a graph showing the shear loss modulus ratio G1″/G2″ as a function of the slab hardness (Shore D).

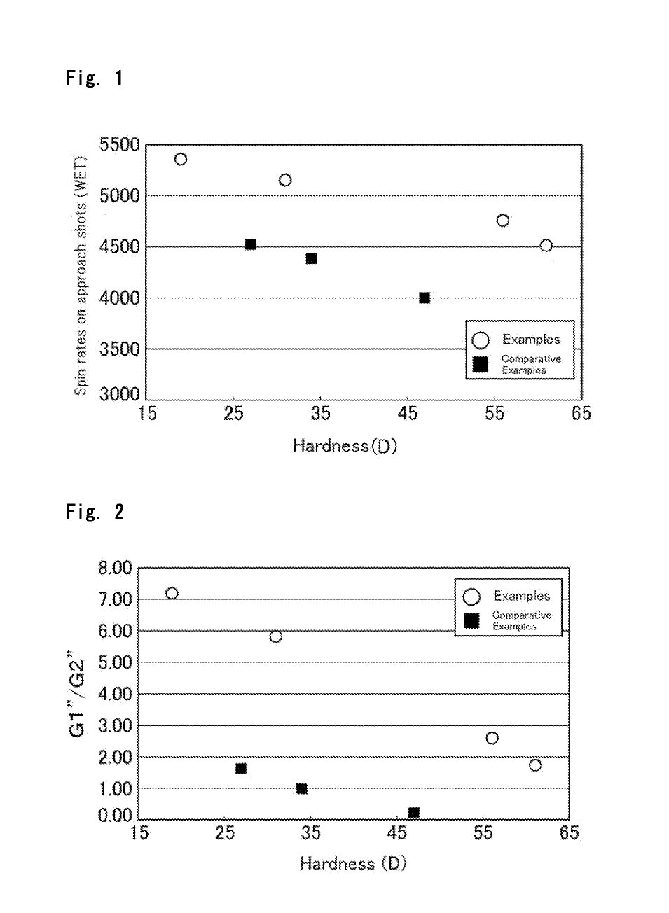

### DESCRIPTION OF EMBODIMENTS

The material for a golf ball of the present invention is an acrylic elastomer having shear loss moduli G1″ (Pa) and G2″ (Pa) which satisfy the following inequality (1):

G1″/G2″>1.65 (1)

when the shear loss moduli are measured with a dynamic viscoelasticity apparatus under measurement conditions for G1″ of mode: shear, vibration frequency: 10 Hz, temperature: −30° C., and strain: 0.05%, and measurement conditions for G2″ of mode: shear, vibration frequency: 10 Hz, temperature: 0° C., and strain: 0.05%.

The inventor of the present invention assumed a mechanism of spin generation on approach shots as mentioned below. Based on the mechanism, the inventor determined the conditions for measuring the shear loss moduli G1″ and G2″ with a dynamic viscoelasticity apparatus.

The clubfaces of short irons and wedges used on approach shots are provided with a plurality of grooves having a width of about 0.8 mm and a depth of about 0.4 mm. In addition, fine unevenness of several μm-order is present on the clubface plane between the grooves. For determination of the measurement conditions for the shear loss modulus G1″, focus is placed on the mechanism that a golf ball slides on a clubface plane while overcoming the several μm-order unevenness on the clubface plane and then trips on the groove on the face to create spin. Namely, the spin rate is influenced by both of the several μm-order unevenness on the clubface plane and the grooves on the face. The measurement conditions for the shear loss modulus G1″ take account more specifically of the influence of the spin created when the golf ball has overcome the several μm-order unevenness. Since the cover deforms relatively a little when the golf ball overcomes the several μm-order unevenness, the measurement strain is set to 0.05%. Moreover, the reason why the measurement is performed under the conditions of the vibration frequency of 10 Hz and the temperature of −30° C. is as follows. The frequency of deformation when the golf ball overcomes the several μm-order unevenness on the clubface plane is of the order of 10⁷ Hz. Based on the time-temperature superposition principle of general polyurethane elastomer, the dynamic viscoelasticity measured under the conditions of temperature: room temperature and vibration frequency: 10⁷ Hz corresponds to the dynamic viscoelasticity measured under the conditions of temperature: −30° C. and vibration frequency: 10 Hz.

Meanwhile, for determination of the measurement conditions for the shear loss modulus G2″, focus is placed on the mechanism that spin is created by the several μm-order fine unevenness on the clubface plane. In measurement of the shear loss modulus G2″, since the cover deforms relatively a little when the golf ball overcomes the several μm-order unevenness, the measurement strain is set to 0.05%. Moreover, the reason why the measurement is performed under the conditions of the vibration frequency of 10 Hz and the temperature of 0° C. is as follows. When a golf ball is hit with a club, the golf ball contacts the club for several hundred micro seconds. If this contact is assumed to correspond to deformation by one shot, the deformation corresponds to deformation at a frequency of several thousand Hz. Based on the time-temperature superposition principle of general polyurethane elastomer, the dynamic viscoelasticity measured under the conditions of temperature: room temperature and vibration frequency: several thousand Hz corresponds to the dynamic viscoelasticity measured under the conditions of temperature: 0° C. and vibration frequency: 10 Hz.

In the case that the inequality (1): G1″/G2″>1.65 is satisfied, the wet spin rate on approach shots increases. From this point of view, the ratio of G1″/G2″ is preferably not less than 1.74. The upper limit of G1″/G2″ is not particularly limited; however, the ratio of G1″/G2″ is preferably not more than 15, and more preferably not more than 10 in terms of moldability.

The acrylic elastomer satisfying the above inequality (1) can be obtained by appropriately adjusting factors such as the particular components forming the acrylic elastomer, the composition ratio of the components, and the structure and molecular weight of the elastomer. Specifically, acrylic elastomers mentioned below may be exemplified.

Examples of the acrylic elastomer satisfying the above inequality (1) in the present invention include acrylic block copolymers which include a polymer block (I) including an acrylic acid ester polymer and a polymer block (II) including a methacrylic acid ester polymer.

The acrylic acid ester polymer constituting the polymer block (I) is a polymer mainly containing acrylic acid ester units. Preferably, the acrylic acid ester units constitute not less than 60 mol %, and especially preferably not less than 80 mol % of the structural units of the acrylic acid ester polymer. The acrylic acid ester polymer constituting the polymer block (I) preferably has a microstructure of a spherical shape to a cylindrical shape, though depending on the kind of the acrylic acid ester forming the acrylic acid ester polymer.

Examples of the acrylic acid ester forming the acrylic acid ester polymer include methyl acrylate, ethyl acrylate, n-propyl acrylate, isopropyl acrylate, n-butyl acrylate, isobutyl acrylate, sec-butyl acrylate, tert-butyl acrylate, amyl acrylate, isoamyl acrylate, n-hexyl acrylate, cyclohexyl acrylate, 2-ethylhexyl acrylate, pentadecyl acrylate, dodecyl acrylate, isobornyl acrylate, phenyl acrylate, benzyl acrylate, phenoxyethyl acrylate, 2-hydroxyethyl acrylate, 2-methoxyethyl acrylate, glycidyl acrylate, and allyl acrylate. The acrylic acid ester polymer may be formed of one, or two or more of these acrylic acid esters.

In particular, the acrylic acid ester polymer constituting the polymer block (I) is preferably a polymer mainly containing structural units derived from at least one acrylic acid ester selected from the group consisting of ethyl acrylate, n-propyl acrylate, isopropyl acrylate, n-butyl acrylate, 2-ethylhexyl acrylate, pentadecyl acrylate, dodecyl acrylate, and 2-methoxyethyl acrylate, in terms of increase in the wet spin rate of golf balls to be obtained. It is more preferably a polymer mainly containing structural units derived from at least one acrylic acid ester selected from the group consisting of ethyl acrylate, n-propyl acrylate, n-butyl acrylate, 2-ethylhexyl acrylate, and dodecyl acrylate, and is particularly preferably a polymer mainly containing structural units derived from n-butyl acrylate.

The acrylic acid ester forming the acrylic acid ester polymer is also preferably a C2 or higher alkyl ester of acrylic acid, namely an acrylic acid alkyl ester in which the ester-forming alkyl group has not less than two carbon atoms, and more preferably not less than three carbon atoms. Conversely, the number of carbon atoms is preferably not more than 10, more preferably not more than 8, and further preferably not more than 6. This structure enables production of golf balls having a high wet spin rate.

The methacrylic acid ester polymer constituting the polymer block (II) is a polymer mainly containing methacrylic acid ester units. Preferably, the methacrylic acid ester units constitute not less than 60 mol %, and especially preferably not less than 80 mol % of the structural units of the methacrylic acid ester polymer. The methacrylic acid ester polymer constituting the polymer block (II) may have a stereoregular microstructure or a non-stereoregular microstructure, and preferably has a syndiotacticity of not more than 80%, especially of 60 to 75%.

Examples of the methacrylic acid ester forming the methacrylic acid ester polymer include methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, isoamyl methacrylate, n-hexyl methacrylate, cyclohexyl methacrylate, 2-ethylhexyl methacrylate, pentadecyl methacrylate, dodecyl methacrylate, isobornyl methacrylate, phenyl methacrylate, benzyl methacrylate, phenoxyethyl methacrylate, 2-hydroxyethyl methacrylate, and 2-methoxyethyl methacrylate. The methacrylic acid ester polymer may be formed of one, or two or more of these methacrylic acid esters.

In particular, the methacrylic acid ester polymer constituting the polymer block (II) is preferably a polymer mainly containing structure units derived from at least one methacrylic acid ester selected from the group consisting of methyl methacrylate, ethyl methacrylate, isopropyl methacrylate, n-butyl methacrylate, tert-butyl methacrylate, cyclohexyl methacrylate, and isobornyl methacrylate, in terms of increase in the wet spin rate of golf balls to be obtained, and is especially preferably a polymer mainly containing structural units derived from methyl methacrylate.

The methacrylic acid ester forming the methacrylic acid ester polymer is also preferably a C10 or lower alkyl ester of methacrylic acid, namely a methacrylic acid alkyl ester in which the ester-forming alkyl group has not more than 10 carbon atoms, more preferably not more than 5, and further preferably not more than 3. This structure enables production of golf balls having a high wet spin rate.

In the acrylic block copolymer, the acrylic acid ester polymer constituting the polymer block (I) and the methacrylic acid ester polymer constituting the polymer block (II) may each further contain, in addition to the structural units derived from the acrylic or methacrylic acid ester, structural units derived from other monomers to the extent not impairing the properties of each of the polymer blocks (in general, at a rate of not more than 40 mol % relative to all the structural units constituting the polymer block).

The other monomers which may partially form the acrylic acid ester polymer or the methacrylic acid ester polymer are not particularly limited. Examples of the monomers include unsaturated carboxylic acids such as methacrylic acid, acrylic acid, and maleic anhydride; olefins such as ethylene, propylene, 1-butene, isobutylene, and 1-octene; conjugated diene compounds such as 1,3-butadiene, isoprene, and myrcene; aromatic vinyl compounds such as styrene, α-methylstyrene, p-methylstyrene, and m-methylstyrene; vinyl acetate; vinyl pyridine; unsaturated nitriles such as acrylonitrile, and methacrylonitrile; vinyl ketones; halogen-containing monomers such as vinyl chloride, vinylidene chloride, and vinylidene fluoride; and unsaturated amides such as acryl amide, and methacryl amide. One, or two or more of the other monomers may be used.

Examples of the acrylic block copolymer in the present invention include those having, in a molecule thereof, at least one di-block structure represented by the formula: (I)-(II), and those having, in a molecule thereof, at least one tri-block structure represented by the formula: (II)-(I)-(II), or the formula: (I)-(II)-(I) (wherein (I) represents a polymer block including an acrylic acid ester polymer, (II) represents a polymer block including a methacrylic acid ester polymer, and - represents a bond between the polymer blocks). In particular, tri-block copolymers represented by the formula: (II)-(I)-(II), or the formula: (I)-(II)-(I) are preferred, and tri-block copolymers represented by the formula: (II)-(I)-(II) (copolymers having a tri-block structure of (II)-(I)-(II)) are more preferred.

Specific examples of the acrylic block copolymer include di-block copolymers such as [poly(n-butyl acrylate)]-[poly(methyl methacrylate)], and [poly(2-ethylhexyl acrylate)]-[poly(methyl methacrylate)]; and tri-block copolymers such as [poly(methyl acrylate)]-[poly(n-butyl methacrylate)]-[poly(methyl acrylate)], [poly(methyl acrylate)]-[poly(2-ethylhexyl methacrylate)]-[poly(methyl acrylate)], [poly(methyl methacrylate)]-[poly(ethyl acrylate)]-[poly(methyl methacrylate)], [poly(methyl methacrylate)]-[poly(n-butyl acrylate)]-[poly(methyl methacrylate)], and [poly(methyl methacrylate)]-[poly(2-ethylhexyl acrylate)]-[poly(methyl methacrylate)]. Particularly in terms of achieving a high wet spin rate of golf balls, tri-block copolymers represented by [poly(methyl methacrylate)]-[poly(n-butyl acrylate)]-[poly(methyl methacrylate)], and [poly(methyl methacrylate)]-[poly(2-ethylhexyl acrylate)]-[poly(methyl methacrylate)] are preferred, and tri-block copolymers represented by [poly(methyl methacrylate)]-[poly(n-butyl acrylate)]-[poly(methyl methacrylate)] are particularly preferred.

The amounts of the polymer block (I) and the polymer block (II) in the acrylic block copolymer are not particularly limited. In terms of achieving a high wet spin rate of golf balls, the amount of the polymer block (I) (in the case where not less than two polymer blocks (I) are included, the total amount of the polymer blocks (I)) relative to the total mass of the acrylic block copolymer is preferably not less than 25% by mass, more preferably not less than 40% by mass, and still more preferably not less than 60% by mass. The amount is preferably not more than 95% by mass, and more preferably not more than 90% by mass. Similarly, the amount of the polymer block (II) (in the case where not less than two polymer blocks (II) are included, the total amount of the polymer blocks (II)) relative to the total mass of the acrylic block copolymer is preferably not less than 5% by mass, and more preferably not less than 10% by mass. The amount is preferably not more than 75% by mass, more preferably not more than 60% by mass, and still more preferably not more than 40% by mass.

The molecular weights of the polymer blocks in the acrylic block copolymer and the molecular weight of the whole acrylic block copolymer are not particularly limited. In terms of achieving a high wet spin rate of golf balls, the weight average molecular weight of the polymer block (I) is preferably not less than 2000, and more preferably not less than 10000. The weight average molecular weight is preferably not more than 400000, and more preferably not more than 300000. Similarly, the weight average molecular weight of the polymer block (II) is preferably not less than 1000, and more preferably not less than 3000. The weight average molecular weight is preferably not more than 400000, and more preferably not more than 100000. Similarly, the weight average molecular weight of the whole acrylic block copolymer is preferably not less than 5000, and more preferably not less than 20000. The weight average molecular weight of the whole acrylic block copolymer is preferably not more than 500000, and more preferably not more than 300000.

Here, the weight average molecular weight is determined by gel permeation chromatography (GPC) calibrated with polystyrene standards.

The method for producing the acrylic block copolymer used in the present invention is not particularly limited, and the copolymer may be produced according to known methods. For example, a method of living polymerization of the monomers forming the polymer blocks is generally employed. Examples of the living polymerization method include anion polymerization using an organic alkali metal compound as a polymerization initiator in the presence of an alkali metal inorganic salt or an alkaline earth metal inorganic salt; anion polymerization using an organic alkali metal compound as a polymerization initiator in the presence of an organic aluminum compound; polymerization using an organic rare earth metal complex as a polymerization initiator; and radical polymerization using an α-halogenated ester compound as an initiator in the presence of a copper compound. Moreover, a method may be employed in which the monomers forming the polymer blocks are polymerized using a polyvalent radical polymerization initiator or a polyvalent radical chain transfer agent so that a mixture containing the acrylic block copolymer to be used in the present invention is prepared.

Examples of commercially available products of the acrylic elastomer include products sold by Kuraray Co., Ltd. under the name of “KURARITY” (e.g. “LA4285”, “LA2250”). The acrylic elastomers may be used alone, or two or more of the acrylic elastomers may be used in admixture.

The material for a golf ball of the present invention may include other resins such as thermoplastic polyurethane elastomers, ionomer resins, thermoplastic polyamide elastomers, thermoplastic polyester elastomers, and thermoplastic styrene elastomers, and the like to the extent not impairing the effects of the present invention. Moreover, the material for a golf ball may include additives such as pigments such as white pigments (e.g. titanium oxide), and blue pigments; weighting agents such as calcium carbonate, and barium sulfate; dispersants; antioxidants; UV absorbents; photostabilizers; and fluorescent materials or fluorescent brighteners.

The amount of the white pigment (such as titanium oxide) for each 100 parts by mass of the resin component is preferably not less than 0.5 parts by mass, and more preferably not less than 1 part by mass. The amount is preferably not more than 10 parts by mass, and more preferably not more than 8 parts by mass. The amount of not less than 0.5 parts by mass can provide hiding properties. The amount exceeding 10 parts by mass may reduce the durability.

The slab hardness of the material for a golf ball of the present invention is preferably not less than 19, and more preferably not less than 21 in Shore D hardness. The slab hardness (Shore D hardness) is preferably not more than 61, and more preferably not more than 57. If the harness is too low, the material tends to cause blocking easily. If the hardness is too high, the spin rate on approach shots may be excessively reduced.

The material for a golf ball of the present invention is applicable to any members forming a golf ball, and is particularly suitably used as a cover material. Thus, in a preferred embodiment, the golf ball produced using the material for a golf ball of the present invention has a core and a cover that is formed of the material for a golf ball of the present invention. Examples of such a golf ball of the present invention include two-piece golf balls having a single-layer core and a cover covering the core; three-piece golf balls which have a core including a center and a single intermediate layer covering the center and a cover covering the core; and multi-piece golf balls which have a core including a center and at least two intermediate layers covering the center and a cover covering the core.

The cover of the golf ball according to the present invention can be prepared by molding using the material for a golf ball (hereinafter, also referred to as “cover material”). Examples of methods for forming the cover include a method of molding the cover material into hollow shells, covering a core with the plurality of hollow shells, and subjecting them to compression-molding (preferably, a method of molding the cover material into hollow half shells, covering a core with the two half shells, and subjecting them to compression-molding), and a method of injection-molding the cover material directly onto a core.

The forming of half shells may be performed by either compression-molding or injection-molding, and preferably by compression-molding. The conditions for compression-molding the cover material into half shells may be, for example, under a pressure of 1 to 20 MPa at a molding temperature of −20° C. to 70° C. plus a flow beginning temperature of the cover material. Under these molding conditions, half shells having a uniform thickness can be formed. Examples of the method for forming a cover using the half shells include a method of covering a core with two half shells and subjecting them to compression-molding. The conditions for compression-molding the half shells to form a cover may be, for example, under a molding pressure of 0.5 to 25 MPa at a molding temperature of −20° C. to 70° C. plus a flow beginning temperature of the cover material. Under these molding conditions, covers for golf balls having a uniform thickness can be formed.

In the present invention, the cover may be formed by injection-molding the cover material directly onto a core. In this case, it is preferable to use upper and lower molds for forming the cover each having a hemispherical cavity with pimples a part of which also serve as retractable hold pins. In the case of forming the cover by injection-molding, the cover can be formed by protruding the hold pins, placing and holding the core with the hold pins, injecting the cover material, and then cooling it. For example, the process is performed by injecting the cover material heated to 150° C. to 250° C. into a mold clamped under a pressure of 9 to 15 MPa in 0.5 to 5 seconds, cooling the cover material for 10 to 60 seconds, and opening the mold.

In the case of forming a cover, indentations called “dimple” are usually formed on the surface. The total number of dimples on the cover is preferably 200 to 500. If the total number is less than 200, the effect of dimples is unlikely to be obtained. If the total number exceeds 500, the effect of dimples is also unlikely to be obtained because the individual size of the dimples is small.

Examples of the shape (shape in plan view) of the dimples include, but are not limited to, circles; polygonal shapes such as substantially triangular shapes, substantially quadrangular shapes, substantially pentagonal shapes, and substantially hexagonal shapes; and other irregular shapes. Any of these shapes may be employed solely, or two or more of these may be employed in combination.

After the cover is formed, the golf ball body is taken out from the mold, and is preferably subjected to surface treatments such as deburring, cleaning, and sandblasting as necessary. If desired, a paint layer or a mark may be formed. The paint layer preferably has a thickness of, but not limited to, not less than 5 μm, and more preferably not less than 7 μm. The thickness is preferably not more than 25 μm, and more preferably not more than 18 μm. If the thickness is less than 5 μm, the paint layer tends to be easy to wear off with continued use of the golf ball. If the thickness is more than 25 μm, the effect of dimples is likely to be reduced, resulting in reduction of the flying performance of the golf ball.

In the present invention, the thickness of the cover of the golf ball is preferably not more than 2 mm, more preferably not more than 1.5 mm, and still more preferably not more than 1 mm. When the thickness is not more than 2 mm, a large outside diameter of the core is obtained, leading to improvement in the resilience performance. The lower limit of the thickness of the cover is not particularly limited. For example, the lower limit is preferably 0.3 mm, more preferably 0.4 mm, and still more preferably 0.5 mm. The thickness of less than 0.3 mm may lead to difficulty in forming the cover by molding.

Next, the core used in the golf ball of the present invention is described. Examples of the structure of the core include a single-layer core, and a core including a center and at least one intermediate layer covering the center. Examples of the core including a center and at least one intermediate layer covering the center include a core including a center and a single intermediate layer covering the center, and a core including a center and a plurality of intermediate layers or multi-layered intermediate layer covering the center. Preferably, the core is spherical in shape. If the core is not spherical, the cover thickness may not be uniform, thereby resulting in reduced covering performance at some parts of the cover. Meanwhile, the shape of the center is ordinarily a sphere. The spherical center may be provided with a linear protrusion(s) to divide the surface of the center. For example, the spherical center may be provided with a linear protrusion(s) to equally divide the surface of the center. Examples of embodiments provided with the linear protrusion include an embodiment in which the surface of the spherical center is provided with a linear protrusion(s) that is integrated with the center, and an embodiment in which the surface of the spherical center is provided with linear protrusions as an intermediate layer.

Supposing, for example, that the spherical center is the earth, the linear protrusions are preferably provided along the equator and any meridians which equally divide the surface of the spherical center. For example, in the case of dividing the surface of the spherical center into eight parts, linear protrusions may be provided along the equator, an arbitrary meridian (0 degrees longitude) and the meridians at 90 degrees east longitude, 90 degrees west longitude, 180 degrees east (west) longitude based on the meridian at 0 degrees longitude. In the case where the linear protrusion(s) is provided, concave portions separated by the linear protrusion(s) are preferably filled by a plurality of intermediate layers, or a single intermediate layer which covers the concave portions, so that the core has a spherical shape. The cross-sectional shape of the linear protrusion is not particularly limited, and may be, for example, an arc, a substantially arc (for example, a shape in which a notch portion is formed at a part where the linear protrusions cross each other or orthogonally cross each other), or the like.

The core or center of the golf ball of the present invention may be produced by heat-press molding a rubber composition (hereinafter, also referred to simply as “rubber composition for a core”) containing, for example, a base rubber, a crosslinking initiator, a co-crosslinking agent, and optionally a filler.

Natural rubber or synthetic rubber may be used as the base rubber, and examples thereof include natural rubber, polybutadiene rubber, polyisoprene rubber, styrene-polybutadiene rubber, and ethylene-propylene-diene rubber (EPDM). Preferred among these is high-cis polybutadiene rubber that has a cis-bond content, which is advantageous for resilience, of not less than 40% by mass, more preferably not less than 70% by mass, and still more preferably 90% by mass.

The crosslinking initiator is intended to be added to crosslink the base rubber component. Preferred examples of the crosslinking initiator include organic peroxides. Specific examples of the organic peroxides include dicumyl peroxide, 1,1-bis(t-butylperoxy)-3,5-trimethylcyclohexane, 2,5-dimethyl-2,5-di(t-butylperoxy)hexane, and di-t-butyl peroxide, and more preferred among these is dicumyl peroxide. The amount of the crosslinking initiator to be added is preferably not less than 0.2 parts by mass, and more preferably not less than 0.3 parts by mass, for each 100 parts by mass of the base rubber. Also, the amount is preferably not more than 3 parts by mass, and more preferably not more than 2 parts by mass. If the amount is less than 0.2 parts by mass, the resulting core tends to be too soft, resulting in reduction of the resilience performance. If the amount exceeds 3 parts by mass, the amount of the co-crosslinking agent to be used needs to be increased to provide appropriate hardness, which tends to lead to insufficient resilience performance.

The co-crosslinking agent is not particularly limited as long as the co-crosslinking agent functions to graft-polymerize onto molecular chains of the base rubber to crosslink the rubber molecules. Examples of the co-crosslinking agent include C3-C8 α,β-unsaturated carboxylic acids and metal salts thereof, and preferably acrylic acid and methacrylic acid, and metal salts thereof. Examples of the metals forming the metal salts include zinc, magnesium, calcium, aluminum, and sodium. In terms of achieving high resilience performance, zinc is preferably used.

The amount of the co-crosslinking agent to be used is preferably not less than 10 parts by mass, and more preferably not less than 20 parts by mass, for each 100 parts by mass of the base rubber. Also, the amount to be used is preferably not more than 50 parts by mass, and more preferably not more than 40 parts by mass. If the amount is less than 10 parts by mass, the amount of the organic peroxide needs to be increased to provide appropriate hardness, and thereby the resilience performance tends to be reduced. If the amount exceeds 50 parts by mass, the resulting core may be too hard, resulting in a poor shot feeling.

The filler that may be contained in the rubber composition for a core is mainly intended to be added as a weighting agent in order to adjust the specific gravity of a golf ball obtained as the final product in the range of 1.0 to 1.5, and may be added as required. Examples of the filler include inorganic fillers such as zinc oxide, barium sulfate, calcium carbonate, magnesium oxide, tungsten powder, and molybdenum powder. The amount of the filler is preferably not less than 2 parts by mass, and more preferably not less than 3 parts by mass, for each 100 parts by mass of the base rubber. Also, the amount is preferably not more than 50 parts by mass, and more preferably not more than 35 parts by mass. If the amount is less than 2 parts by mass, it tends to be difficult to adjust the weight. If the amount is more than 50 parts by mass, the weight fraction of the rubber component may be small and the resilience performance tends to be lowered.

The rubber composition for a core may appropriately contain additives such as an organic sulfur compound, an antioxidant, and a peptizer, in addition to the base rubber, crosslinking initiator, co-crosslinking agent, and filler.

Diphenyl disulfides can be suitably used as the organic sulfur compound. Examples of the diphenyl disulfides include diphenyl disulfide; mono-substituted products thereof such as bis(4-chlorophenyl)disulfide, bis(3-chlorophenyl)disulfide, bis(4-bromophenyl)disulfide, bis(3-bromophenyl)disulfide, bis(4-fluorophenyl)disulfide, bis(4-iodophenyl)disulfide, and bis(4-cyanophenyl)disulfide; di-substituted products thereof such as bis(2,5-dichlorophenyl)disulfide, bis(3,5-dichlorophenyl)disulfide, bis(2,6-dichlorophenyl)disulfide, bis(2,5-dibromophenyl)disulfide, bis(3,5-dibromophenyl)disulfide, bis(2-chloro-5-bromophenyl)disulfide, and bis(2-cyano-5-bromophenyl)disulfide; tri-substituted products thereof such as bis(2,4,6-trichlorophenyl)disulfide, and bis(2-cyano-4-chloro-6-bromophenyl)disulfide; tetra-substituted products thereof such as bis(2,3,5,6-tetrachlorophenyl)disulfide; and penta-substituted products thereof such as bis(2,3,4,5,6-pentachlorophenyl)disulfide, and bis(2,3,4,5,6-pentabromophenyl)disulfide. These diphenyl disulfides have some influence on the state of cure of the rubber vulcanizate, and thereby enhance the resilience performance. Particularly in terms of achieving high resilience performance of the golf ball, diphenyl disulfide or bis(pentabromophenyl)disulfide, among these, is preferably used. The amount of the organic sulfur compound for each 100 parts by mass of the base rubber is preferably not less than 0.1 parts by mass, and more preferably not less than 0.3 parts by mass. Also, the amount is preferably not more than 5.0 parts by mass, and more preferably not more than 3.0 parts by mass.

The amount of the antioxidant to be added is preferably not less than 0.1 parts by mass but not more than 1 part by mass for each 100 parts by mass of the base rubber. The amount of the peptizer to be added is preferably not less than 0.1 parts by mass but not more than 5 parts by mass for each 100 parts by mass of the base rubber.

The conditions for heat-press molding the rubber composition for a core may be appropriately set according to the formulation of the rubber composition. Preferably, heating is usually performed at a temperature of 130° C. to 200° C. for 10 to 60 minutes, or in two steps at a temperature of 130° C. to 150° C. for 20 to 40 minutes and subsequently at a temperature of 160° C. to 180° C. for 5 to 15 minutes.

The diameter of the core used in the golf ball of the present invention is preferably not less than 38 mm, more preferably not less than 39.0 mm, and still more preferably not less than 40.8 mm. Also, the diameter is preferably not more than 42.2 mm, more preferably not more than 42 mm, and still more preferably not more than 41.8 mm. If the diameter is less than the lower limit, the cover tends to be too thick, thereby reducing the resilience performance. Conversely, if the diameter is more than the upper limit, the cover tends to be too thin, thereby leading to difficulty in forming the cover by molding.

In the case that the core has a diameter ranging from 38 to 42.2 mm, the amount of compression deformation (shrink in the compression direction) of the core as determined by applying a load from 98 N as an initial load to 1275 N as a final load is preferably not less than 2.40 mm, more preferably not less than 2.50 mm, and still more preferably not less than 2.60 mm. The amount of compression deformation is preferably not more than 3.20 mm, and more preferably not more than 3.10 mm. If the amount of compression deformation is less than 2.40 mm, a hard and bad shot feeling may be obtained. If the amount of compression deformation is more than 3.20 mm, the resilience performance may be lowered.

In a preferred embodiment, the core has a difference in hardness between the surface and core of the core. The difference between the surface hardness and the central hardness in JIS-C hardness is preferably not less than 10, and more preferably not less than 12. Also, the difference between the surface hardness and the central hardness is preferably not more than 40, more preferably not more than 35, and still more preferably not more than 30. The difference of more than 40 may result in reduced durability. The difference of less than 10 may lead to a hard shot feeling and a large impact. The surface hardness in JIS-C hardness of the core is preferably not less than 65, more preferably not less than 70, and still more preferably not less than 72. The surface hardness (JIS-C hardness) is preferably not more than 100. If the surface hardness is less than 65, the surface tends to be too soft, and the resilience performance is likely to be lowered, leading to reduction of the flight distance. Conversely, if the surface hardness is more than 100, the surface may be too hard, thereby leading to a poor shot feeling. The central hardness in JIS-C hardness of the core is preferably not less than 45, and more preferably not less than 50. The central hardness is preferably not more than 70, and more preferably not more than 65. If the central hardness is less than 45, the core of the core may be too soft, leading to reduction of the durability. If the central hardness is more than 70, the core may be too hard, resulting in a poor shot feeling. The difference in hardness of the core can be made by providing an intermediate layer that is harder than the center, or by appropriately selecting the heat-molding conditions for the center. In the present invention, the central hardness of a core refers to a hardness determined by cutting the core into two halves and measuring the halves at the central point of the cut plane with a spring type JIS-C hardness tester.

The surface hardness of a core refers to a hardness determined by measuring the surface of the obtained spherical core with a spring type JIS-C hardness tester. In the case of a core having a multi-layered structure, the surface hardness of the core refers to the hardness of the surface of an outermost layer of the core.

In the case where the core of the golf ball of the present invention has a structure including a center and at least one intermediate layer covering the center, the rubber composition for a core may be used as a center material. The diameter of the center is preferably not less than 30 mm, and more preferably not less than 32 mm. Also the diameter is preferably not more than 41 mm, and more preferably not more than 40.5 mm. If the diameter is less than 30 mm, the thickness of the intermediate layer or the cover needs to be increased compared with the desired thickness, which may result in reduction of the resilience performance. If the diameter is more than 41 mm, the thickness of the intermediate layer or the cover needs to be decreased compared with the desired thickness, which tends not to allow the intermediate layer or the cover to function sufficiently.

Examples of the material for the intermediate layer include cured products of rubber compositions, ionomer resins, thermoplastic polyamide elastomers sold by Arkema under the name of “Pebax (registered trademark)” (e.g. Pebax 2533), thermoplastic polyester elastomers sold by Du Pont-Toray Co., Ltd. under the name of “Hytrel (registered trademark)” (e.g. Hytrel 3548, Hytrel 4047), thermoplastic polyurethane elastomers sold by BASF Japan Ltd. under the name of “Elastollan (registered trademark)” (e.g. Elastollan NY97A), and thermoplastic polystyrene elastomers sold by Mitsubishi Chemical Corporation under the name of “Rabalon (registered trademark)”. These materials for the intermediate layer may be used alone, or a plurality of the materials may be used as a blend.

Examples of the ionomer resins include, in particular, ionomer resins obtained by neutralizing with a metal ion at least part of the carboxyl groups of a copolymer of ethylene and an α,β-unsaturated carboxylic acid having 3 to 8 carbon atoms; and ionomer resins by neutralizing with a metal ion at least part of the carboxyl groups of a terpolymer of ethylene, an α,β-unsaturated carboxylic acid having 3 to 8 carbon atoms, and an α,β-unsaturated carboxylic acid ester; and mixtures of these.

Specific examples of commercial products (indicated by trade name) of the ionomer resins include products sold by Du Pont-Mitsui Polychemicals Co., Ltd. under the name of “Himilan (registered trademark)” (e.g. Himilan 1555 (Na), Himilan 1557 (Zn), Himilan 1605 (Na), Himilan 1706 (Zn), Himilan 1707 (Na), Himilan AM 3711 (Mg), and terpolymer ionomer resins including Himilan 1856 (Na) and Himilan 1855 (Zn)). Other examples thereof include commercially available ionomer resins from Du Pont such as “Surlyn (registered trademark)” (e.g. Surlyn 8945 (Na), Surlyn 9945 (Zn), Surlyn 8140 (Na), Surlyn 8150 (Na), Surlyn 9120 (Zn), Surlyn 9150 (Zn), Surlyn 6910 (Mg), Surlyn 6120 (Mg), Surlyn 7930 (Li), Surlyn 7940 (Li), Surlyn AD 8546 (Li), and terpolymer ionomer resins including Surlyn 8120 (Na), Surlyn 8320 (Na), Surlyn 9320 (Zn), and Surlyn 6320 (Mg)). Still other examples include commercially available ionomer resins from ExxonMobil Chemical Company such as “Iotek (registered trademark)” (e.g. Iotek 8000 (Na), Iotek 8030 (Na), Iotek 7010 (Zn), Iotek 7030 (Zn), and terpolymer ionomer resins including Iotek 7510 (Zn) and Iotek 7520 (Zn)). Here, Na, Zn, Li, Mg and the like in the parentheses following the trade names of the ionomer resins refer to metal species of the metal ions for neutralization.

The intermediate layer may further include additives such as a weighting agent (e.g. barium sulfate, tungsten), an antioxidant, and a pigment.

In the case where a composition containing a rubber composition as a main component (not less than 50% by mass) is used for the intermediate layer, the thickness of the intermediate layer is preferably not less than 1.2 mm, more preferably not less than 1.8 mm, and still more preferably not less than 2.4 mm. Also, the thickness is preferably not more than 6.0 mm, more preferably not more than 5.2 mm, and still more preferably not more than 4.4 mm.

In the case where a composition containing a resin as a main component (not less than 50% by mass) is used for the intermediate layer, the thickness of the intermediate layer is preferably not less than 0.3 mm, more preferably not less than 0.4 mm, and still more preferably not less than 0.5 mm. Also, the thickness is preferably not more than 2.5 mm, more preferably not more than 2.4 mm, and still more preferably not more than 2.3 mm. The thickness of more than 2.5 mm may result in reduction of the resilience performance of golf balls to be obtained. The thickness of less than 0.3 mm may fail to suppress excessive spin on driver shots.

The method for forming the intermediate layer is not particularly limited. For example, the following methods may be employed: a method including preliminarily forming the composition for an intermediate layer into half shells, covering the center with the two half shells, and subjecting them to compression-molding, and a method including injection-molding the composition for an intermediate layer directly onto the center to cover the center.

The hardness of the intermediate layer of the golf ball of the present invention is preferably not less than 40, more preferably not less than 45, and still more preferably not less than 50 in Shore D hardness. Also, the hardness (Shore D hardness) is preferably not more than 80, more preferably not more than 70, and still more preferably not more than 65. The hardness of not less than 40 contributes to increase in the difference in hardness between the harder outer side and the softer inner side of the core. As a result, a high launch angle and low spin rate are achieved, leading to a greater flight distance of the golf ball. In addition, the harness of not more than 80 leads to an excellent shot feeling, as well as improving the spin performance and the controllability of the golf ball. Here, the hardness of the intermediate layer is a slab hardness obtained by molding the resin composition for an intermediate layer into a sheet and measuring the sheet according to the below-mentioned method. The hardness of the intermediate layer can be adjusted by appropriately selecting factors such as the combination used in the resin component or rubber composition, and the amounts of the additives.

In the case where the golf ball of the present invention is a thread-wound golf ball, a thread-wound core may be used as the core. In this case, examples of the thread-wound core to be used include those which have a center formed of a cured product of the rubber composition for a core, and a rubber thread layer formed by winding a rubber thread in its stretched state around the center. The rubber thread to be wound around the center may be the same as conventional ones which have been used for wound thread layers for thread-wound golf balls, and examples thereof include those produced by vulcanizing a rubber composition containing natural rubber or a combination of natural rubber and synthesized polyisoprene, together with sulfur, a vulcanization auxiliary, a vulcanization accelerator, an antioxidant, and the like. The rubber thread is wound around the center while being stretched to about ten times its original length, to prepare the thread-wound core.

### EXAMPLES

The present invention will be described in detail referring to, but not limited to, examples.

### [Evaluation Methods]

### (1) Shear Loss Moduli G1″ and G2″

The shear loss moduli G1″ and G2″ of a cover material were measured under the following conditions.

Device: rheometer ARES (TA Instruments)

Measurement sample: a 10-mm-wide sample (distance between clamps: 10 mm) cut out of a 2-mm-thick sheet that is prepared by press-molding the cover material.

Measurement mode: torsion (shear)

Measurement temperature: 0° C., −30° C.

Vibration frequency: 10 Hz

Measured strain: 0.05%

The shear loss modulus of the cover material is a shear loss modulus of a material prepared by adding 4 parts by mass of titanium oxide to 100 parts by mass of the resin component.

### (2) Spin Rate on Approach Shots (Dry Spin Rate, Wet Spin Rate, Spin Retention)

An approach wedge (DUNLOP SPORTS CO. LTD., SRIXON I-302 (compatible with new groove regulations), shaft S) was attached to a swing robot (Golf Laboratories, Inc.), and the robot was used to hit a golf ball at a head speed of 21 m/sec. The hit golf ball was continuously photographed, and the spin rate (rpm) was determined based on these photographs. The measurement was performed 10 times for each golf ball, and the average value of the determined values was treated as the spin rate. The dry spin rate is a spin rate obtained in the test with a dried clubface and golf ball, whereas the wet spin rate is a spin rate obtained in the test with a water-wetted clubface and golf ball. The spin retention was calculated based on the following formula.

Spin retention (%)=100×[wet spin rate]/[dry spin rate]

### (3) Slab Hardness (Shore D Hardness)

A composition for an intermediate layer or a cover material was heat press-molded into an about 2-mm-thick sheet, and the sheet was stored at 23° C. for two weeks. Three or more of the sheet were stacked so as to avoid being affected by measurement instruments such as a measurement substrate. Then, the stack was measured using a P1 type auto rubber hardness tester (KOBUNSHI KEIKI CO., LTD.) including a spring type Shore D hardness tester as prescribed by ASTM-D2240.

The slab hardness of the cover material is a slab hardness of a material prepared by adding 4 parts by mass of titanium oxide to 100 parts by mass of the resin component.

### (4) Hardness of Core (JIS-C Hardness)

The JIS-C hardness of the surface of a core was measured using a P1 type auto rubber hardness tester (KOBUNSHI KEIKI CO., LTD.) including a spring type JIS-C hardness tester, and this hardness was treated as the surface hardness of the core. Also, the core was cut into hemispheres and the JIS-C hardness of the hemisphere at the central point of the cut plane was measured. This hardness was treated as the central hardness of the core.

### (5) Amount of Compression Deformation of Core (mm)

The amount of deformation in the compression direction (shrink in the compression direction) of a spherical specimen (core) was measured by applying a load from 98 N as an initial load to 1275 N as a final load to the core.

### [Preparation of Golf Ball]

### (1) Preparation of Center

A rubber composition for a center prepared according to the formulation shown in Table 1 was kneaded, and then heat-pressed at 170° C. for 15 minutes in upper and lower molds each having a hemispherical cavity. Thus, a spherical center (diameter: 38.5 mm) was prepared.

TABLE 1

| Rubber composition for center | A |
|---|---|
| Polybutadiene rubber | 100 |
| Zinc acrylate | 38 |
| Zinc oxide | 5 |
| Diphenyl disulfide | 0.5 |
| Dicumyl peroxide | 1 |

Parts by mass
Polybutadiene rubber: “BR730 (high-cis polybutadiene)”, product of JSR CORPORATION
Zinc acrylate: “ZNDA-90S”, product of NIHON JYORYU KOGYO CO., LTD.
Zinc oxide: “Ginrei R”, product of TOHO ZINC CO., LTD.
Diphenyl disulfide: product of SUMITOMO SEIKA CHEMICALS CO., LTD.
Dicumyl peroxide: “PERCUMYL (registered trademark) D”, product of NOF CORPORATION

### (2) Preparation of Core

Next, the materials for an intermediate layer according to the formulation shown in Table 2 were extruded using a twin-screw kneading extruder to prepare pellets of the composition for an intermediate layer. The extrusion was performed under the following conditions: a screw diameter of 45 mm, screw revolutions of 200 rpm, and a screw L/D ratio of 35. Here, the composition was heated to 150° C. to 230° C. in the die of the extruder. The obtained composition for an intermediate layer was injection-molded onto the center obtained as mentioned above, and thus a core (diameter: 41.7 mm) having a center and an intermediate layer covering the center was prepared.

TABLE 2

| Core No. | | 1 |
|---|---|---|
| Center | Composition for center | A |
| | Center diameter (mm) | 38.5 |
| Intermediate | Composition for intermediate | a |
| layer | layer | |
| | HIMILAN 1605 | 50 |
| | HIMILAN AM7329 | 50 |
| | Slab hardness (Shore D) | 64 |
| | Intermediate layer thickness (mm) | 1.6 |
| Physical | Core diameter (mm) | 41.7 |
| properties of | Surface hardness of core | 98 |
| core | (JIS-C hardness) | |
| | Central hardness of core | 65 |
| | (JIS-C hardness) | |
| | Difference in hardness of core | 33 |
| | (JIS-C hardness) | |
| | Amount of compression | 2.55 |
| | deformation of core (mm) | |

HIMILAN 1605: sodium ion-neutralized ethylene/methacrylic acid copolymer ionomer resin (DU PONT-MITSUI POLYCHEMICALS CO., LTD.)
HIMILAN AM 7329: zinc ion-neutralized ethylene/methacrylic acid copolymer ionomer resin (DU PONT-MITSUI POLYCHEMICALS CO., LTD.)

### (3) Forming of Half Shells

The cover material shown in Table 3 was dry-blended with titanium oxide, and the blend was mixed using a twin-screw kneading extruder. Thus, pellets of the cover material were prepared. The extrusion was performed under the following conditions: a screw diameter of 45 mm, screw revolutions of 200 rpm, and a screw L/D ratio of 35. Here, the composition was heated to 150° C. to 230° C. in the die of the extruder. The obtained cover material pellets were put in the lower mold of the mold set for forming half shells, in an amount of one pellet per each depressed portion of the lower mold, and then pressurized. Thus, half shells were formed. The compression molding was performed under the following conditions: a molding temperature of 170° C., a molding time of 5 minutes, and a molding pressure of 2.94 MPa.

### (4) Forming of Cover

The core prepared in the step (2) was covered by the two half shells prepared in the step (3) in a concentric manner, and they were compression-molded to form a cover. The compression-molding was performed under the following conditions: a molding temperature of 145° C., a molding time of 2 minutes, and a molding pressure of 9.8 MPa.

The surface of the obtained golf ball body was sandblasted and marked. Then, a clear paint was applied thereto and dried in an oven at 40° C. Thus, a golf ball with a diameter of 42.7 mm and a mass of 45.3 g was obtained. The results of evaluation on the wet spin performance of the obtained golf balls were also shown in Table 3.

TABLE 3

| Golf ball No. | | | 1 | 2 | 3 | 4 | 5 | 6 | 7 |
|---|---|---|---|---|---|---|---|---|---|
| Cover | Acrylic | Sample product | 100 | — | — | — | — | — | — |
| material | elastomer/ | LA4285 | — | 100 | — | — | — | — | — |
| | physical | LA4285/LA2250 | — | — | 100 | — | — | — | — |
| | properties | LA2250 | — | — | — | 100 | — | — | — |
| | | Elastollan NY85A | — | — | — | — | 100 | — | — |
| | | Elastollan NY80A | — | — | — | — | — | 100 | — |
| | | Elastollan NY97A | — | — | — | — | — | — | 100 |
| | | Slab hardness (Shore D) | 61 | 56 | 31 | 19 | 34 | 27 | 47 |
| | | G1″/G2″ | 1.74 | 2.60 | 5.81 | 7.17 | 1.00 | 1.65 | 0.25 |
| Ball | Cover thickness (mm) | | 0.5 | 0.5 | 0.5 | 0.5 | 0.5 | 0.5 | 0.5 |
| | | Dry spin rate (rpm) | 5150 | 5350 | 5900 | 6200 | 6050 | 6300 | 5800 |
| | Physical | Wet spin rate (rpm) | 4511 | 4758 | 5153 | 5358 | 4383 | 4522 | 4000 |
| | properties | Spin retention (wet/dry) % | 88 | 89 | 87 | 86 | 72 | 72 | 69 |

Parts by mass
Acrylic elastomer: 100 parts by mass, titanium oxide: 4 parts by mass

The materials shown in Table 3 are as follows. The amount of units of poly(methyl methacrylate) in each acrylic elastomer is shown in Table 4.

Sample product, KURARITY LA 4285, KURARITY LA 4285/LA 2250, and KURARITY LA 2250: triblock copolymers represented as [poly(methyl methacrylate) block 1]-[poly(n-butyl acrylate) block]-[poly(methyl methacrylate) block 2](KURARAY CO., LTD.)

Elastollan NY85A: polyurethane (BASF)

Elastollan NY80A: polyurethane (BASF)

Elastollan NY97A: polyurethane (BASF)

TABLE 4
Acrylic elastomer

| | Sample | KURARITY | KURARITY | KURARITY |
|---|---|---|---|---|
| | product | LA4285 | LA4285/LA2250 | LA2250 |
| Amount of | 54% by | 50% by | 40% by | 30% by |
| units of | mass | mass | mass | mass |
| poly(methyl | | | | |
| methacrylate) | | | | |
| in polymer | | | | |

In the comparison between golf balls having a similar cover hardness, the golf balls satisfying the above formula (I) had a higher wet spin rate and spin retention than the golf balls not satisfying it.

### INDUSTRIAL APPLICABILITY

The present invention can provide a golf ball which has a high spin rate in wet conditions and stops well on approach shots.

1. A material for a golf ball comprising an acrylic elastomer, and
having shear loss moduli G1″ (Pa) and G2″ (Pa) which satisfy the following inequality (1):
G1″/G2″>1.65 (1)
when the shear loss moduli are measured with a dynamic viscoelasticity apparatus under measurement conditions for G1″ of mode: shear, vibration frequency: 10 Hz, temperature: −30° C., and strain: 0.05%, and measurement conditions for G2″ of mode: shear, vibration frequency: 10 Hz, temperature: 0° C., and strain: 0.05%.

2. The material for a golf ball according to claim 1, wherein the acrylic elastomer is an acrylic block copolymer which comprises, in a molecule thereof, at least one polymer block (I) comprising an acrylic acid ester polymer and at least one polymer block (II) comprising a methacrylic acid ester polymer.

3. The material for a golf ball according to claim 1, wherein the acrylic elastomer is an acrylic block copolymer which comprises, in a molecule thereof, at least one triblock structure of the formula: (II)-(I)-(II) or the formula: (I)-(II)-(I) (wherein (I) represents a polymer block comprising an acrylic acid ester polymer, (II) represents a polymer block comprising a methacrylic acid ester polymer, and - represents a bond between the polymer blocks).

4. The material for a golf ball according to claim 1, wherein the acrylic elastomer is an acrylic block copolymer which comprises, in a molecule thereof, at least one triblock structure of the formula: (II)-(I)-(II) (wherein (I) represents a polymer block comprising an acrylic acid ester polymer, (II) represents a polymer block comprising a methacrylic acid ester polymer, and - represents a bond between the polymer blocks).

5. The material for a golf ball according to claim 2, wherein the polymer block (I) comprises an n-butyl acrylate polymer, and the polymer block (II) comprises a methyl methacrylate polymer.

6. The material for a golf ball according to claim 1, having a slab hardness of 19 to 61 in Shore D hardness.

7. The material for a golf ball according to claim 1, which is a cover material.

8. The material for a golf ball according to claim 2, wherein the acrylic acid ester polymer is derived from an acrylic acid alkyl ester in which the alkyl group has a number of carbon atoms of at least two but not more than 10.

9. The material for a golf ball according to claim 2, wherein the methacrylic acid ester polymer is derived from a methacrylic acid alkyl ester in which the alkyl group has a number of carbon atoms of not more than 10.

10. The material for a golf ball according to claim 2, wherein the amount of the polymer block (I) (in the case where not less than two polymer blocks (I) are comprised, the total amount of the polymer blocks (I)) relative to the total mass of the acrylic block copolymer is at least 25% by mass but not more than 95% by mass, and
the amount of the polymer block (II) (in the case where not less than two polymer blocks (II) are comprised, the total amount of the polymer blocks (II)) relative to the total mass of the acrylic block copolymer is at least 5% by mass but not more than 75% by mass.

11. The material for a golf ball according to claim 2, wherein the polymer block (I) has a weight average molecular weight of at least 2000 but not more than 400000.

12. The material for a golf ball according to claim 2, wherein the polymer block (II) has a weight average molecular weight of at least 1000 but not more than 400000.

13. A golf ball comprising a member formed of the material for a golf ball according to claim 1.
